(19) United States
(12) Patent Application Publication
(10) Pub. No.: US 2003/0214402 A1
(43) Pub. Date: Nov. 20, 2003

(54) Discreet surveillance and alarm system

(76) Inventors: Darrel H. Sheinman, Berkshire (GB); Julian Richard Longson, London (GB); Philip Lane, London (GB); John Michael Duckworth, Manchester (GB)

Correspondence Address: William C. Milks, III, Russo & Hale LLP, 401 Florence Street, Palo Alto, CA, 94301, US

(21) Appl. No.: 10/150,254

(22) Filed: May 17, 2002

(51) Int. Cl. G08B 1/08

(52) U.S. Cl. 340/539.13; 340/571; 340/988

(57) ABSTRACT

A surveillance and alarm system linked through a global communications satellite system to monitor the status of a protected mobile asset(s) or person(s). The surveillance and alarm system issues an alert in response to detection of an alarm condition. Alarm conditions include both a monitored variable, such as geographical position of the mobile asset or person with respect to an allowable range of positions, as well as triggered alarm conditions, which can be automatic such as in response to loss of main power or which can be manual such as in response to activation of a wired or wireless alarm button depressed by a person in response to a security threat. The surveillance and alarm system provides global, real-time protection for mobile equipment and personnel, as well as two-way communication between the mobile entity and a remote location.

### FIELD OF THE INVENTION

The present invention relates to security systems and, more particularly, to security systems for non-stationary property and personnel such as cargo ships and crew. Specifically, various embodiments of the present invention provide a surveillance and alarm system linked through a global communications system to monitor the status of a protected mobile asset(s) or person(s), that issues an alert in response to detection of an alarm condition. Preferably, alarm conditions can include both a monitored variable, such as geographical position with respect to an allowable range of positions, as well as triggered alarm conditions, which can be automatic such as in response to loss of main power or which can be manual such as in response to activation of a wired or wireless alarm button depressed by a person in response to a security threat.

### BACKGROUND OF THE INVENTION

The tracking of mobile equipment and personnel is important for the management of transportation and shipping businesses. For example, one known tracking system is the PurpleFinder® Reporter system available from Pole Star Space Applications Ltd. located in the United Kingdom. The PurpleFinder Reporter system is a highly effective yet inexpensive real-time fleet management system used by the merchant shipping industry to locate and communicate with vessels throughout the world in a reliable manner. It is a secure web-based solution that provides automatic information on the vessel latitude/longitude, speed and heading, and two-way message/email communications without the need for local system investment and administration. It uses the existing vessel Sat-C GMDSS system and is activated without boarding. The user requires only an Internet-enabled computer with standard web browser to access private fleet information with associated meteorological data, and a range of available functions including estimated time of arrival (ETA), distance calculator, and map zoom in/out/pan. For advanced users, the PurpleFinder Reporter system can be hyperlinked to third-party Internet or Intranet sites and by XML delivery into MIS/ERP systems.

While monitoring of position and course is an important facet of asset management, so too is asset security. Hijacking of assets including piracy of merchant ships is a concern to the merchant shipping industry. Known tracking systems rely on transceivers to report position. If the transceiver is disabled by disconnecting from the power source or is otherwise disabled, position reporting is disrupted. Assuming that the position reporting system is not disabled, position reporting over time can evidence a deviation from a valid course of direction or movement outside a valid geographical region from which a security breach (e.g., act of piracy) can be deduced. Disadvantageously, however, position reporting does not provide an immediate indication of a security breach.

It would therefore be desirable to provide a surveillance and alarm system that could issue an alert in the event there is a detected security breach occurring in connection with deployed mobile equipment or personnel.

It would also be desirable to provide a surveillance and alarm system that could automatically monitor various conditions that can arise in connection with a security breach, such as an attempt to disable the system or deviation outside a geographical region, to issue an alert if one of the alarm conditions occurs.

Additionally, it would be desirable to enable the alert to be issued through activation by a person in the event that the person detects an actual or threatened security problem.

### SUMMARY OF THE INVENTION

One embodiment of the present invention provides a discreet surveillance and alarm system associated with a mobile entity for automatically responding to one or more predefined alarm conditions to sound an alert. Preferably, the discreet surveillance and alarm system also responds to manual activation to sound the alert. The discreet surveillance and alarm system includes a global communications system to broadcast the alert to a remote location. The discreet surveillance and alarm system forms part of a new extension to the PurpleFinder® service, called PurpleFinder Guard. In one preferred embodiment, the discreet surveillance and alarm system is configured for deployment to directly address the increasing safety and security concerns of the merchant shipping industry.

Considered in more detail, the discreet surveillance and alarm system utilizes the Inmarsat D+, Mini Sat-C, and cellular communication services using discreet/decoy equipment to provide vessel tracking and alarm notification independently of vessel power and Sat-C availability. The discreet surveillance and alarm system can also form a Sat-C replacement for non-SOLAS vessels or vessels with incompatible Sat-C hardware.

The discreet surveillance and alarm system in accordance with the various embodiments of the present invention has significant advantages for the world's major shipping and chartering organizations. It is a solution for organizations that wish to improve productivity and security, reduce costs, improve customer service, and gain a competitive edge.

The foregoing and other objects, features, and advantages of the discreet surveillance and alarm system in accordance with the present invention will become more readily apparent from the following description of the preferred embodiments in conjunction with the accompanying drawings.

### BRIEF DESCRIPTION OF THE DRAWINGS

FIG. 1 is a schematic block diagram of one embodiment of the discreet surveillance and alarm system of the present invention.

FIG. 2 is a wiring diagram for an implementation of the system shown in FIG. 1.

FIG. 3 illustrates installation considerations for the system shown in FIG. 2 aboard a shipping vessel.

FIG. 4 is a cable pin out diagram for the system shown in FIG. 2.

### DETAILED DESCRIPTION OF THE PREFERRED EMBODIMENTS

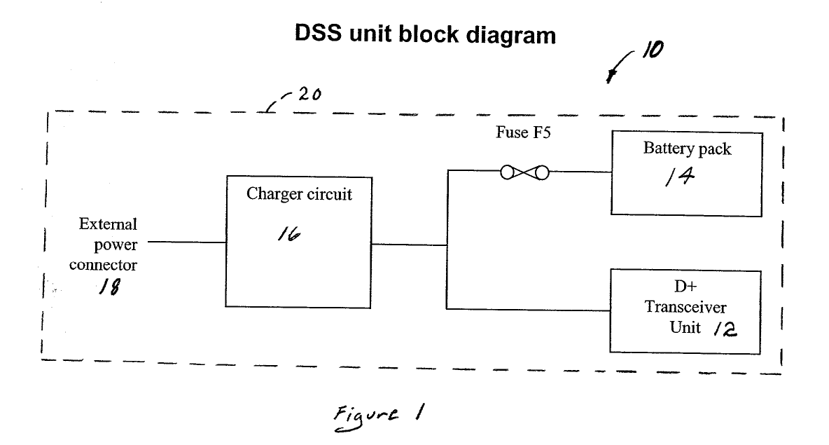

One embodiment of the discreet surveillance and alarm system (hereafter referred to as the DSAS system) in accordance with the present invention is generally indicated by the numeral 10 shown in the block diagram that appears in FIG. 1. The operation of the DSAS system 10 will be described in more detail later.

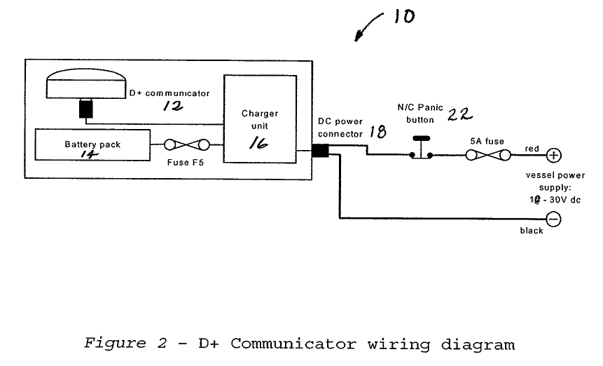

As shown in FIGS. 1 and 2, the DSAS system 10 comprises an Inmarsat D+ transceiver unit 12 having an integrated global positioning system (GPS) and satellite antenna. For example, the Inmarsat D+ transceiver unit 12 can comprise a SkyWave DMR200 D+ terminal available from TMC Innovations Ltd. in the United Kingdom.

The DSAS system 10 also comprises a backup battery pack 14 (for example, three 12 VDC, 7 amp-hour batteries). Additionally, the DSAS system 10 comprises a multistage intelligent battery charger circuit 16 for recharging the battery pack 14. As shown in FIG. 1, the charger circuit 16 is preferably connected to the battery pack 14 by a fuse F5. The charger circuit 16 is connected to an external DC power connector 18. The Inmarsat D+ transceiver unit 12, battery pack 14, charger circuit 16, and fuse F5 are preferably housed in an IP68 certified box 20 having approximate dimensions of 40×20×20 cm. The box 20 can be mounted to a structure using Sikaflex® 292 bonding agent and/or by using a protective mounting frame (not shown). The charger circuit 16 is connected through the external power connector 18 to an external DC power source using a standard DC power cable. As shown in FIG. 2, the DSAS system 10 also preferably comprises a compression panic alarm 22 and cabling to connect the compression panic alarm to the external power connector 18. The DSAS can optionally include a mobile data terminal. The DSAS system 10 can be accessed with a personal computer (PC) having an Internet connection with Netscape 4.1/Internet Explorer 4.01 (or above) browser.

The portion of the DSAS system 10 shown in FIG. 1 is preferably assembled before dispatching the system to an end user. The portion of the DSAS system 10 shown in FIG. 1 is assembled as follows.

First, the Inmarsat D+ transceiver unit 12 is programmed with the following scripts: default program (swcfg) and DSS program (swstd) to enable the operational modes that will be described in more detail later. Second, the portion of the DSAS system shown in FIG. 1 is set up as follows: a) ensure that the power fuse F5 is disconnected; and b) set dip switches to •••• (1,2,3,4, where •=on). Third, in the case that the DSAS system 10 is implemented using the DMR200 D+ terminal, the DMR200 D+ cable is installed as follows: a) the red power cable is connected to Radio unit POS; b) the black cable is connected to Radio unit GND; and c) the digital input cable is connected to Radio unit OP5. Fourth, the DMR200 D+ terminal is installed on a mounting plate, and the Conxall connector is attached. Fifth, all screws are replaced on the DMR200 D+ terminal, and the lid of the box 20 and mounting bracket are attached, assuring that a cutout in the mounting bracket is above the DMR200 D+ terminal (at the opposite end to the power input provided by the external power connector 18). Sixth, a “DO NOT PAINT” sticker is preferably applied to the lid. A visual inspection of cabling and dip switches and test of the power input alarm are then preferably performed. The following extra parts are also included with the DSAS system 10, as shown in FIG. 2: a) 5A fuse and sealed fuse holder; and, preferably, an N/C twist to release panic button 22 with cable gland.

The DSAS system 10 is then ready for installation on mobile equipment and/or in association with personnel to be protected. The nature of discreet surveillance requires a sophisticated range of deployment options. Variable location mounting (for example, on an antenna deck, bridge, stem, funnel, etc. of a shipping vessel) can enhance the security provided by the DSAS system 10. Also, deployment of decoy boxes (including empty boxes) can enhance security. Preferably, a customized deployment plan is established in advance with the end user to optimize security.

Once the portion of the DSAS system 10 shown in FIG. 1 has been assembled as described above and provided to an end user with the remainder of the system, installation by an installation engineer for the end user is as follows. After assembly as described above, the DSAS system 10 preferably comprises the following components for installation: the box 20 containing the DMR200 D+ terminal 12, battery pack 14, fuse F5, and charger circuit 16 connected to the external DC power connector 18; the N/C twist to release panic button with spiral gland 22, an external 5A fuse and fuse holder, and a stainless steel mounting bracket. A wiring diagram of the DSAS system 10 is shown in FIG. 2.

In one preferred embodiment, the DSAS system 10 forms a self-contained shipping vessel tracking system. The DSAS system 10 comprises the DMR200 D+ terminal 12 satellite tracking transceiver, battery pack 14 comprising three 12 VDC, 7 amp-hour sealed lead acid (SLA) batteries wired in parallel (providing 21 amp-hours in total) and the multistage charger circuit 16 to recharge the batteries. The DSAS system 10 also requires an external DC power source to maintain the battery charge. Typical power consumption is shown in Table I.

TABLE I
DSAS System 10 Power Consumption Figures-SkyWave DMR200

| Mode | Current Draw | Power Consumption |
|---|---|---|
| Receive & GPS | 183 mA | 2.2 W |
| Transmit | 833 mA | 10 W |

On disconnection of power, the DSAS system 10 will operate for approximately seven days. Operation of the DSAS system 10 is completely automatic, and the only user intervention that may be required after installation is to restore the external DC power source in the event of disconnection.

The box 20 should not be painted. Paint could obstruct the communication path to a satellite.

The DSAS system 10 is shipped in a powered-down state. To prepare the DSAS system 10 for operation, the following is performed during installation. Initially, the box 20 is sat on the metal base plate and opened. The metal mount and plastic lid of the battery pack 14 are removed. The battery pack 14 is opened so that the batteries can be checked. A voltage above 11 VDC shows that the batteries are still holding a charge. Below 11 VDC, the batteries should be placed on charge before installing. Ideally, the batteries should be fully charged before installation, and, thus, it may be advisable to put the batteries on charge while the rest of the installation is taking place.

Next, the internal 5A input fuse F5 is located next to a screw terminal block J1 and connected to the terminal block. The installer should ensure that the 5A fuse is inserted in F5 (on the top edge of the circuit board, close to the connection block for the battery). The DSAS system 10 may be damaged if this fuse is not in place while the system is in operation.

The installer should then ensure that the white SkyWave DMR200 D+ transceiver terminal 12 is powered up. This is indicated by the red STAT light flashing periodically. Also, the installer should test the power input connector 18 by temporarily attaching the external DC power supply cable. When the DMR200 D+ transceiver terminal 12 detects external power, LED OP5 should light after approximately 20 seconds. When the cable is disconnected, LED OP5 should go off after approximately 20 seconds.

The installer then replaces the plastic lid and assembles the remainder of the mount around the unit using the bolts supplied. The plastic lid and metal top plate are replaced in such a manner as to ensure that the cutout in the metal top plate is located above the DMR200 D+ transceiver terminal 12 (the transceiver is situated at the opposite end to the external DC power connector 18).

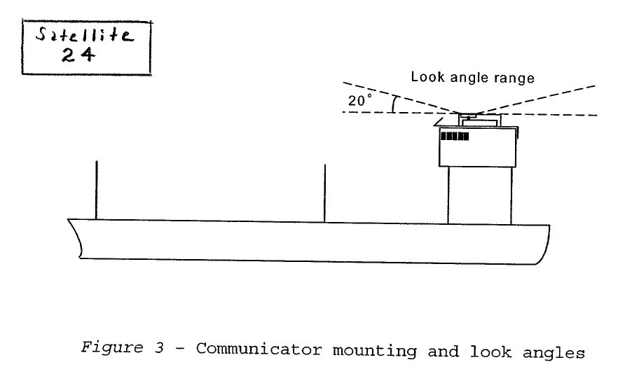

To install the DSAS system 10 on a vessel, the following procedure is followed. First, a suitable position is selected for installation of the DSAS system 10 on the vessel. The installer selects a suitable installation position. Preferably, as shown in FIG. 3, consideration is given to the following factors during selection of an installation site: a) the DSAS system 10 should have a clear and unobstructed view of the satellite 24; b) there should be no obstructions within the look angle range of the DSAS system; and c) the DSAS system should be positioned as far from other communication systems as practical (at least 300 mm).

Once the installation site is selected, the DSAS system 10 is securely fastened to the vessel superstructure. The installer drills locating holes for the box 20 using the base of the metal mount as a template. The metal mount is designed to be bolted down at the base with bolts to attach the metal base plate to the installation position. M8 bolts are recommended for this. A torque of 21 Nm is recommended when tightening the bolts, as over tightening could cause the bolts to sheer. The installer should ensure that: a) the box 20 is securely attached to the vessel superstructure; and b) the venting plugs are not obstructed.

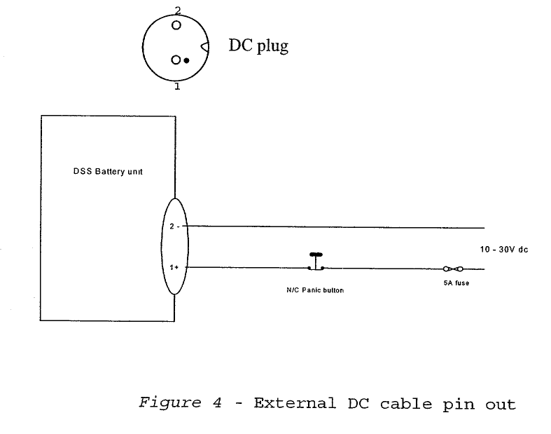

The DSAS system 10 is then connected to the vessel DC power supply, as shown in FIGS. 2 and 3. The installer prepares the external cable assembly in accordance with the cable schematic shown in FIGS. 2 and 4, installs the panic button 22 in a suitable position, and feeds the power cable out to the installation position. All loose cables are preferably secured with cable ties or straps at approximately 30 cm (1 ft.) intervals.

As shown in FIGS. 2 and 4, the input voltage range for the DSAS system 10 is 10 to 30 VDC. The cable pin-out for the external power supply cable is shown in FIG. 4. The installer attaches the external power supply plug, and seals the connection with self-amalgamating tape.

The panic button 22 should be installed in a position that is convenient for operation by the crew. The panic button is preferably installed in series with a 5A fuse between the positive external DC power source connection and the external power connector 18 that provides the power connection to the DSAS system 10, as shown in FIG. 4. Alternatively, both wired and wireless panic buttons can be included. The DSAS system is now installed and ready for use.

The DSAS system 10 operates automatically and requires no user intervention. When the SkyWave DMR200 D+ transceiver terminal 12 is powered up, the “STAT” and “ERR” LEDs should light for approximately two seconds, then go off. In normal operation, the “STAT” LED flashes approximately once every eight seconds.

The DSAS system 10 automatically switches over to its internal battery supply in the event of external power failure. In the event of an external power failure, the DSAS system 10 switches to emergency reporting mode (typically at a rate of one report every 30 minutes). The DSAS system 10 should operate independently for approximately seven days under backup battery power. Normal operation will resume when the external power supply is reconnected.

The panic button 22 operates by isolating the DSAS system 10 from the external power source, and can therefore be used to test the system. When pressed, the panic button 22 stays enabled until it is released by twisting the red actuator. The user must ensure that the button is released for normal operation.

The DSAS system 10 in accordance with the present invention has various operational modes. One mode is Automatic Position Reporting (APR) which will now be described. The DSAS system 10 provides position reporting that is automatically reported at preselected time intervals. Position reporting can occur automatically at user specified intervals such as each X hours (for example, a 24-hour “health check” or six-hour intervals for more frequent reporting). The DSAS system 10 formats the position reporting data in an automatic position reporting (APR) data packet. The APR data packet preferably includes: Vessel Identification (ID), date/time, latitude/longitude, speed, course, and geocoded vicinity statement. The APR data packets are communicated via the Inmarsat D+ communication service that is available globally. The APR data packets can be used at a remote location to provide various functionality. The functionality includes displaying a single latest position report or full journey history on Admiralty charts, “polling” the vessel for an immediate position report, and calculating the estimated time of arrival (ETA). Various commands can also be issued at the remote location to modify/stop the position report interval over air and establish two-way message communication using an optional data terminal.

The DSAS system 10 monitors and responds to a plurality of exception events. By way of example, and without limiting the scope of the present invention, one exception event is “Main Power Down.” Another exception event is “Panic Alarm Activated.” A third exception event is “Geofence Entered/Departed.” Other exception events are also contemplated.

In the case that an exception event occurs during monitoring, the DSAS system 10 responds by exiting the APR mode and entering an Exception Alarm Position Reporting (EPR) mode. Considered in more detail, if an exception event corresponding to a predefined alarm condition occurs, then the DSAS system 10 discontinues the standard APR mode described above, and instead enters the EPR mode. In the EPR mode, the DSAS system 10 generates an EPR report each Y minutes (for example, 30 minutes). If required, the EPR alert is routed to nominated email/SMS destinations. Also, the DSAS system 10 is set to require manual intervention to STOP/RESTART APRs.

The DSAS system 10 incorporates a satellite transceiver such as the DRM200 D+ transceiver terminal rather than a cellular system to provide global, real-time tracking with two-way communication. The built-in battery pack 14 provides power in the event that external power is disrupted. The DSAS system 10 includes circuitry to detect when the main external power is disrupted such as when a hijacker cuts the power cabling, and enters the “Main Power Down” exception mode resulting in an alert being sent. Additionally, the DSAS system 10 includes a panic alarm in the form of wired and wireless panic buttons, which a person presses to enter the “Panic Alarm Activated” exception mode resulting in an alert being transmitted. Because global positioning can be determined, the DSAS system 10 enters the “Geofence Entered/Departed” exception mode when a protected entity transgresses beyond specified geographical limits resulting in an alert being communicated. The DSAS system 10 therefore provides a global, real-time security system for mobile equipment and personnel.

While various embodiments of the discreet surveillance and alarm system have been shown and described, it will be understood that various changes, substitutions, modifications, alterations, and adaptations thereof will occur to persons skilled in the art without departing from the scope of the invention. Thus, it will be appreciated that the protection afforded the present invention should not be limited except in accordance with the claims and their equivalents.

What is claimed is:

1. A surveillance and alarm system for a mobile entity, comprising:
a transceiver associated with the mobile entity;
an external power supply for the transceiver associated with the mobile entity;
a communication link to connect the transceiver associated with the mobile entity to a satellite transceiver system;
a second communication link to connect the satellite transceiver system to a remote location;
means for detecting an exception event; and
means coupled to the detecting means and to the transceiver associated with the mobile entity for causing an alert to be sent to the remote location.

2. The surveillance and alarm system according to claim 1, further comprising a backup battery pack to supply power in the event that the external power supply is disrupted.

3. The surveillance and alarm system according to claim 1 wherein the exception event is disruption of the external power supply.

4. The surveillance and alarm system according to claim 1, further comprising a panic alarm, and wherein the exception event is activation of the panic alarm.

5. The surveillance and alarm system according to claim 4 wherein the panic alarm is a wired device.

6. The surveillance and alarm system according to claim 4 wherein the panic alarm is a wireless device.

7. The surveillance and alarm system according to claim 1, further comprising means for specifying an allowable geographical region for the mobile entity, and wherein the exception event is transgression of the mobile entity outside the allowable geographical region.

8. The surveillance and alarm system according to claim 1 wherein the alert comprises a data packet.

9. The surveillance and alarm system according to claim 8 wherein the data packet comprises entity identification (ID), date/time, latitude/longitude, speed, course, and geocoded vicinity statement.

10. The surveillance and alarm system according to claim 8 wherein the mobile entity is a shipping vessel and the data packet comprises vessel identification (ID), date/time, latitude/longitude, speed, course, and geocoded vicinity statement.
